(19) United States
(12) Patent Application Publication
(10) Pub. No.: US 2016/0012158 A1
(43) Pub. Date: Jan. 14, 2016

(54) METHOD FOR DESIGNING A MATERIAL

(71) Applicant: SHARK MITIGATION SYSTEMS PTY LTD, Western (AU)

(72) Inventors: Raymond Smith, Doonan (AU); Nathan HART, Crawley (AU)

(21) Appl. No.: 14/773,352

(22) PCT Filed: Mar. 6, 2014
(86) PCT No.: PCT/AU2014/000215

§ 371 Date: Sep. 6, 2015

(30) Foreign Application Priority Data
Mar. 6, 2013 (AU) 2013900766

(51) Int. Cl. G06F 17/50

(52) U.S. Cl. CPC G06F 17/50

(57) ABSTRACT

A method of designing a material comprising the steps of defining one or more ocean locations and measuring or calculating reflectance spectra at said locations along one or more predefined viewing angles. From each reflectance spectra, a wavelength range located in or around a maximum region of said reflectance spectra is selected and a material is created by applying colours from each of the wavelength ranges to portions of the material surface.

### FIELD OF THE INVENTION

The present invention relates to a method of producing a design for a material. The material may be applied to apparel for underwater use, such as wetsuits, or other underwater apparatus. The invention relates also to the material and wetsuits resulting from the method.

### BACKGROUND TO THE INVENTION

There are a range of recreational and commercial activities undertaken in the oceans where there is a risk of attack by a shark. Diving, surfing and other similar sports, for example, place people in locations where shark attacks may occur. With an increasing number of shark attacks occurring in areas around certain stretches of coastlines, systems for reducing the likelihood of shark attack are more frequently being adopted.

Electronic devices claiming to repel sharks are one such possibility for reducing the likelihood of shark attack. However, these devices have the disadvantage of requiring additional equipment to be taken into the ocean, which may not be ideal for all activities.

The present invention relates to a method for producing a material, which when applied to underwater apparel, such as a wetsuit, is aimed at reducing the likelihood of attack by shark. The resulting wetsuit of the present invention may be used alone, or in conjunction with other shark deterrent systems to reduce the likelihood of shark attack.

Various wetsuits have been designed with the aim of reducing the likelihood of shark attack. These approaches may be based either on the concept of making the suit less visible (cryptic) to the shark, or by ensuring the suit design is clearly visible (conspicuous) but with a pattern which the shark is likely to avoid. In the latter case, there are a range of sea animals that employ particular colouration patterns that act as a warning to other sea creatures that the animal may be poisonous. For example, sea snakes of certain species have banding of black and white, or other colours extending horizontally across their bodies. Alternatively, the pattern may simply be aimed at ensuring the shark does not confuse the person with a usual food source, such as a seal.

The methods of the present invention utilise both of the abovementioned techniques, however employ research conducted into the expected visual discrimination characteristics of sharks likely to be involved in an attack, along with modelling of how the shark's vision is expected to operate in various ocean locations.

### SUMMARY OF THE INVENTION

According to one aspect of the present invention there is provided a method of designing a material comprising the steps of:

defining one or more ocean locations;
measuring or calculating reflectance spectra at said locations along one or more predefined viewing angles;
selecting from each reflectance spectra a wavelength range located in or around a maximum region of said reflectance spectra; and creating the material by applying colours from each of the wavelength ranges to portions of the material surface.

Preferably each of the ocean locations comprises a depth and/or a geographic location.

Preferably the method includes the step of defining a plurality of time values associated with each ocean location, each of the time values corresponding to a particular time of day and/or year, wherein the reflectance spectra are measured or calculated at each ocean location at each time value.

In a preferred embodiment, the reflectance spectra are measured or calculated at each ocean location are averaged over the time values to define the reflectance spectra at each viewing angle.

In a preferred embodiment, the viewing angles include towards the sun, away from the sun and 90 degrees to the sun.

Preferably the colours selected are applied to the material in a camouflage patchwork pattern.

In a preferred embodiment, the step of calculating the visual discrimination characteristics including the spatial resolving power of at least one species of shark and applying patches of the patchwork pattern to the material such that the size of the patches do not fall below the spatial resolving power.

In one embodiment, the material comprises portions of a first colour, a second colour and a third colour, wherein the first colour is defined by RGB values in the ranges 90 to 100/180 to 195/210 to 220, the second colour is defined by RGB values in the ranges −20 to −10/75 to 85/105 to 115 and the third colour is defined by RGB values in the ranges 5 to 15/110 to 120/140 to 150.

In one embodiment, the first, second and third colours are defined by the RGB values, 99/188/216, −14/81/108 and 10/115/145.

In accordance with a second aspect of the present invention, there is provided a method of designing a material comprising the steps of: defining one or more sets of ocean locations;

calculating the visual discrimination characteristics of at least one species of shark at said ocean locations; and
creating the material by applying a pattern to portions of the material surface based on said visual discrimination characteristics.

Preferably the method includes the steps of measuring or calculating reflectance spectra at said locations along one or more predefined viewing angles and selecting said colours based on maximizing contrast with the background at said locations.

Preferably the method includes the steps of calculating or estimating the spatial resolving power of each species of shark.

In a preferred embodiment, the spatial resolving power as represented in cycles per degree for each species of shark is calculated or estimated and the pattern applied to the material comprises a series of bands where the band spacing is determined based on the cycles per degree for the shark to ensure the bands are discernible by the shark at a set of predefined distances.

Preferably the spatial resolving power is adjusted for expected ambient lighting conditions at said ocean locations at selected time values.

In one embodiment, the method includes the further step of calculating or estimating the variance of said band spacing based on depth at said ocean locations.

In accordance with a third aspect of the present invention, there is provided a material produced in accordance with the method of either the first or second aspect of the invention.

In accordance with a fourth aspect of the present invention, there is provided an item of underwater apparel formed from the material.

### BRIEF DESCRIPTION OF THE DRAWINGS

The invention will now be described, by way of example, with reference to the following drawings, in which:

FIG. 1 comprises graphs of reflectance spectra calculated at a first ocean location at various viewing angles and time values;

FIG. 2 comprises graphs of reflectance spectra calculated at a second ocean location at various viewing angles and time values;

FIG. 3 comprises graphs of reflectance spectra calculated at a third ocean location at various viewing angles and time values;

FIG. 4 comprises graphs showing the reflectance spectra at each of the first, second and third ocean locations averaged over the time values;

FIG. 5 comprises a table showing reflectance spectra in wavelength converted into 1931 CIE xy chromaticity coordinates and corresponding sRGB values;

FIG. 6 is a view of a resulting wetsuit material;

FIG. 7 comprises views of a wetsuit formed of the wetsuit material of FIG. 6;

FIG. 8 is a table showing maximum spatial resolving power for certain species of sharks estimated from ocular optics and anatomical measurements;

FIG. 9a is a table showing the relationship between distance to target and the distance subtended by an angle of one degree;

FIG. 9b is a table showing the required band width based on the table of FIG. 9a and a selected spatial resolving power of around 0.3 cycles per degree;

FIG. 10 is a first embodiment of a wetsuit produced by the method of the second aspect of the present invention;

FIG. 11 is a second embodiment of a wetsuit produced by the method of the second aspect of the present invention;

FIG. 12 is a third embodiment of a wetsuit produced by the method of the second aspect of the present invention; and

FIG. 13 is an adhesive patterned sheet designed according to the second aspect of the invention for application to the lower surface of a surfboard;

FIG. 14 shows predicted conspicuous reflectance spectra calculated from averaged cryptic reflectance spectra;

FIG. 15 is a table showing conspicuous reflectance spectra along different viewing angles.

FIG. 16 is a table showing relationship between eye axial length, lens diameter and focal length for different species of shark;

FIG. 17 shows the relationship between eye axial length and focal length of lens diameter for the shark eye;

FIG. 18 shows the mean spectral reflectance of the tapetum from two species of shark, normalised to a maximum of 0.9 at the wavelength of peak reflectance;

FIG. 19 shows the spectral transmittance of the combined ocular media of the blacktip shark;

FIG. 20 is a table showing the rod to cone ratio and photoreceptor dimensions for various species of shark;

FIG. 21 is a table of threshold discrimination distances for three viewing-direction specific time and season averaged R_{cryptics} for a diver near Perth at 15m at noon in summer,

FIG. 22 is a table of threshold discrimination distances for three viewing-direction specific time and season averaged R_{conspicuous} for a diver near Perth at 15m at noon in summer;

FIG. 23 is a table of threshold discrimination distances for three viewing-direction specific time and season averaged R_{cryptics} for a swimmer at in summer in the morning; and

FIG. 22 is a table of threshold discrimination distances for three viewing-direction specific time and season averaged R_{conspicuous} for a swimmer at in summer in the morning.

### DETAILED DESCRIPTION OF PREFERRED EMBODIMENTS

The present invention relates to methods for forming a material along with the resulting material and items to which the material is applied. The invention will be described with reference to use on wetsuits but it will be appreciated that the material may be applied to other items of underwater apparel, or underwater apparatus.

A first method of the invention relates to designing a material aimed at reducing the visibility of the resulting wetsuit, and hence the wearer, in certain defined conditions in which there is considered an increased risk of an attack by a shark. For example, shark attack data suggests that surfers on the surface of the water and divers at particular depths in particular locations are more likely to be at risk of shark attack than people in other locations.

The method of the invention comprises selection of a plurality of ocean locations at which there is considered to be an increased risk of shark attack. Each ocean location may comprise both a depth and geographical location. For each of the ocean locations, a reflectance spectrum is measured or calculated, the reflectance spectra providing an indication of relative reflectance at each wavelength of at least the visible spectrum.

At each ocean location, there is also defined one or more viewing angles. A plurality of reflectance spectra are therefore measured or calculated at each location, one associated with each viewing angle. The viewing angles are selected to provide an indication of the various angles at which a shark may view a person at that location. For example, the viewing angles may comprise directions toward the sun, away from the sun and/or at 90 degrees from the sun.

There are also defined a plurality of time values associated with each ocean location, wherein the time values correspond to a particular time of day. Time values may also correspond with particular times of the year. Each of the reflectance spectra measured or calculated at each location and for each viewing angle are also therefore measured or calculated for each time value.

Each of the reflectance spectra obtained from a particular ocean location are analysed to define a wavelength range in which the reflectance is maximized. If no clear such wavelength is definable for a particular reflectance spectra, then such a reflectance spectra may be ignored. For example, at certain viewing angles at particular times of day, there may be no clear wavelengths where reflectance is maximized.

From the analysis of the reflectance spectra, a plurality of wavelength ranges therefore result. The wetsuit material is formed by applying colours from each of these wavelength ranges to portions of the wetsuit material surface. A wetsuit may then be formed from the resulting wetsuit material.

In one application of the method of the present invention, the ocean locations were chosen to comprise depths of 0.1 m (i.e. corresponding to a swimmer) and 15 m and 5 m (i.e. corresponding to a diver). The ocean locations also comprised geographical locations comprising the ocean near Perth for the 0.1 m and 15 m depths and the ocean near Ningaloo reef, Coral Bay for the 5 m depth.

The viewing angles were selected to include towards the sun, away from the sun, 90 degrees to the sun and looking up from below. Further, the time values were chosen to comprise morning in winter, noon in winter, morning in summer and noon in summer.

From these ocean locations, viewing angles and time values, the reflectance spectra were calculated. The reflectance spectra were calculated by software, based on characteristics associated with each of the ocean locations. The characteristics included salinity, cloud cover, humidity, pressure, wind speed, temperature and chlorophyll-a concentration. It will be appreciated however that the reflectance spectra may also be based on empirical data rather than calculation.

For an object that reflects light diffusely, the spectral radiance L_{t(λ)} leaving the surface of the target is:

$${L}_{t ( λ )} = \frac{{R}_{t ( λ )} {E}_{( λ )}}{π} \qquad ( 1 )$$

Where R_{t(λ)} is the diffuse spectral reflectance of the target and E_{(λ)} is the spectral irradiance illuminating the target. The inherent (Weber) contrast C_{t(λ0)} of the target at wavelength λ when viewed at a distance z=0 m is:

$${C}_{t ( λ , 0 )} = \frac{{L}_{t ( λ )} {L}_{b ( λ )}}{{L}_{b ( λ )}} \qquad ( 2 )$$

L_{b(λ)} is the spectral radiance of the background. Substituting (1) into (2) gives:

$${C}_{t ( λ , 0 )} = \frac{{R}_{t ( λ )} {E}_{( λ )}}{π {L}_{b ( λ )}} - 1 \qquad ( 3 )$$

For a cryptic target, the ideal inherent contrast is zero. Setting C_{t(λ,0)} to zero and solving equation (3) for R_{t(λ)} gives:

$${R}_{cryptic ( λ )} = \frac{π {L}_{b ( λ )}}{{E}_{( λ )}} \qquad ( 4 )$$

Thus, R_{cryptic} is the spectral reflectance that gives zero contrast to the background radiance.

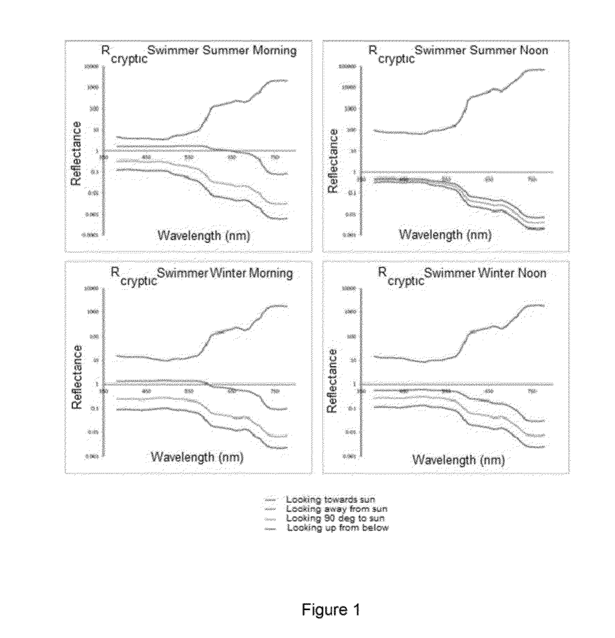

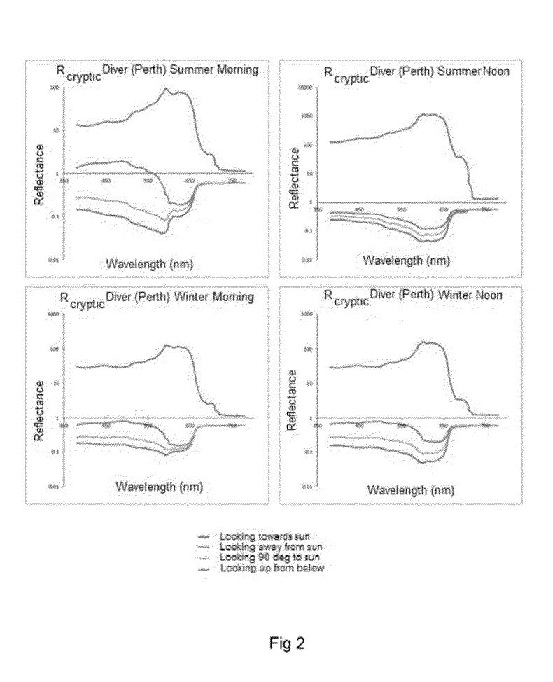

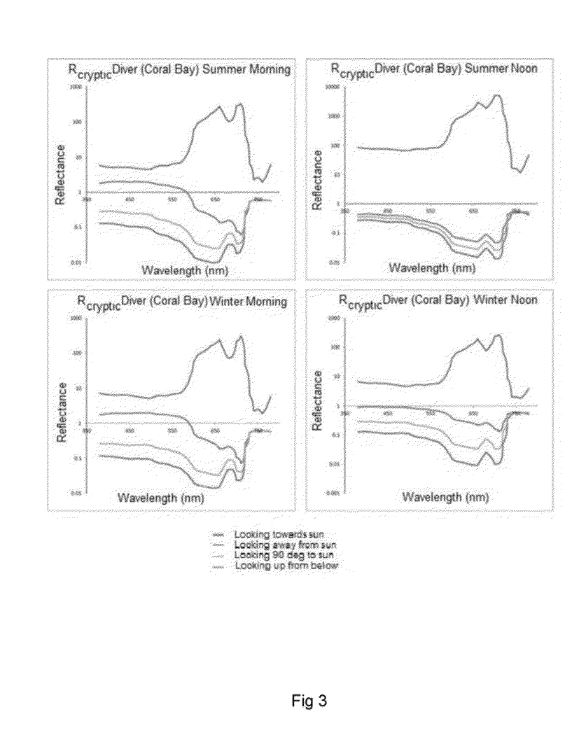

FIGS. 1 to 3 shows the resulting reflectance spectra obtained. From the resulting reflectance spectra at each location, averages over the time values were obtained to result in reflectance spectra at each location for each viewing angle. The reflectance spectra for ‘looking up from below’ were discounted based on values higher than unity. That is, it would not be possible to make the silhouette of an object cryptic unless it emitted light.

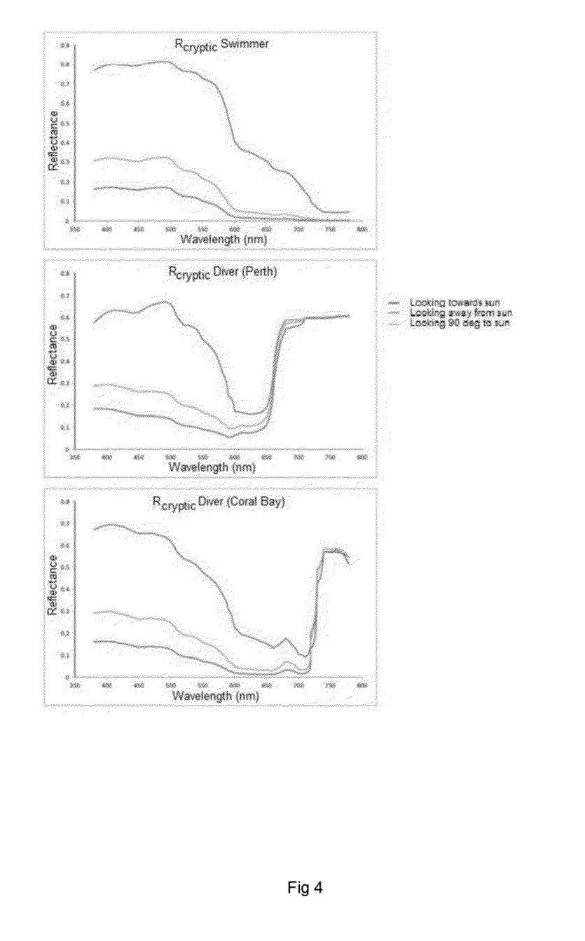

FIG. 4 shows the resulting time and season averaged reflectance spectra. These reflectance spectra were then analysed to define the wavelength ranges around or near the maximum reflectance. FIG. 5 comprises a table showing the maximum reflectance wavelengths for each of the ocean locations, time values and viewing angles provided and converted into 1931 CIE xy chromaticity coordinates and corresponding sRGB values. The time values were then averaged to provide colour information for each viewing angle at each ocean location.

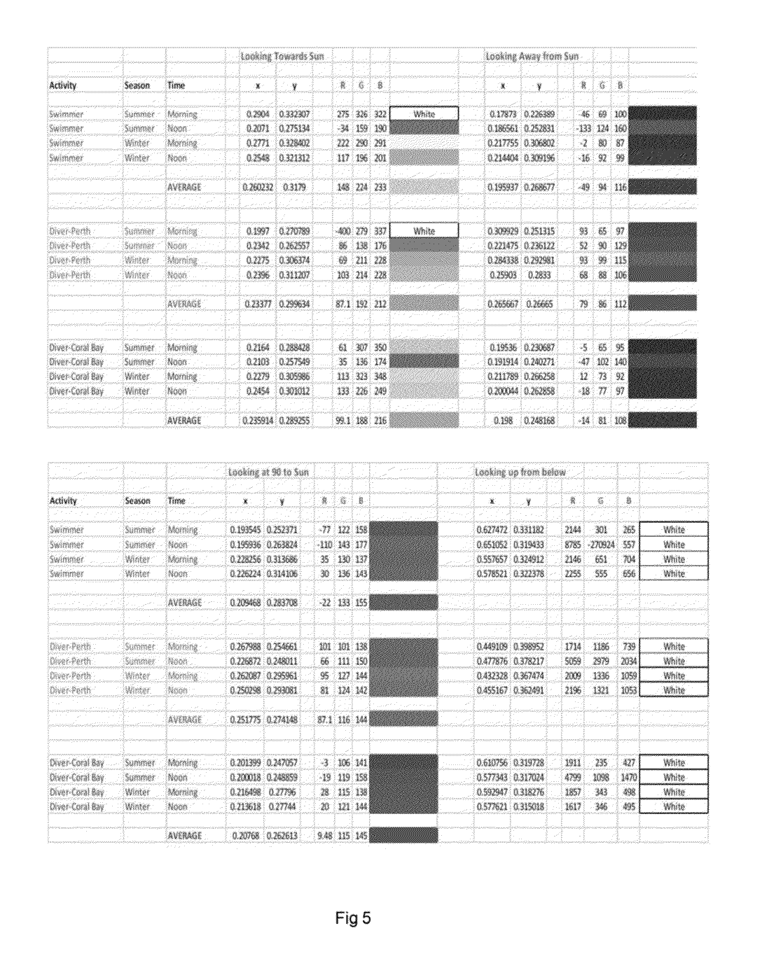

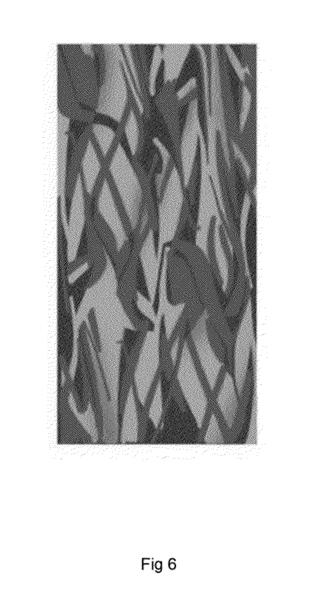

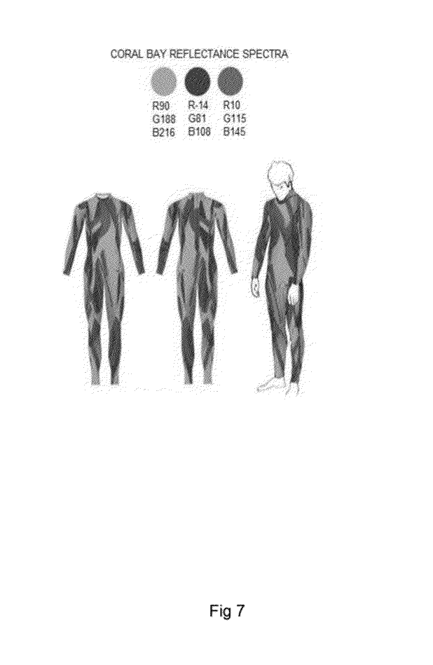

A wetsuit material can then be created by applying corresponding colours from this table. FIG. 6 shows an example of a resulting wetsuit material pattern. Preferably, the colours chosen are provided in a random camouflage style pattern. FIG. 7 shows a wetsuit formed from the wetsuit material of FIG. 6.

The colours chosen may be selected based on a particular location at various viewing angles. In the example shown, three colours are selected for the location of Coral Bay at the viewing angles shown in FIG. 5. That is, the RGB values comprise 99/188/216, −14/81/108 and 10/115/145.

A second method of the present invention relates to forming a material that both mimics the pattern of an animal expected to be avoided by sharks and is designed to be optimised for viewing by sharks in various ocean locations. The second method will be described with reference to a horizontally striped pattern of the type that may be found on species of sea snakes.

The second method also comprises steps in which the reflectance spectra are measured or calculated as described previously. That is, reflectance spectra are obtained at a selection of ocean locations, at various viewing angles and times of day. From these reflectance spectra, colours are selected based on maximizing the contrast with the background at said locations.

The second method of the invention includes the steps of calculating or estimating the visual discrimination characteristics of sharks and applying banding to the wetsuit material based on these characteristics.

The visual discrimination characteristics of the shark calculated or estimated includes the spatial resolving power as represented in cycles per degree. From the cycles per degree, the size of the banding applied may be calculated at a set of predefined distances. The most appropriate banding size may then be selected based on the expected application of the material.

The spatial resolving power of species of sharks may be estimated from ocular optics and anatomical measurements of ganglion cell packing densities. FIG. 8 shows a table of such estimated spatial resolving power represented in cycles per degree. The method of the invention involves selection of appropriate ranges of spatial resolving power based on species of sharks which are known or likely to attack humans. For example, based on sharks such as the bull shark or tiger shark, a spatial resolving power in the order of 3-11 cycles per degree may be appropriate. Further, a selection in the range of 3 cycles per degree (i.e. the lower limit) may be appropriate in order to ensure the banding pattern applied based on this information is discernible.

The discernibility of the banding pattern will also be affected by ambient light conditions. The method therefore involves the further step of accounting for ambient lighting in the selected ocean locations at appropriate time values and adjusting the spatial resolving power value accordingly. This estimation may be based on inferences drawn from visual acuity of other species in various lighting conditions where information regarding the relevant species of shark is not available. For example, humans have an average maximum visual acuity under photopic (bright light) conditions of approximately 60 cycles per degree but around 6 cycles per degree under scotopic (dim light) conditions). It may therefore be estimated that a similar factor of 10 reduction should be applied to the spatial resolving power of the selected shark species based on the fact that sharks often feed in low light conditions of dawn and dusk. A selection therefore of 0.3 cpd may be appropriate in one embodiment.

The method preferably also includes the further step of adjusting the appropriate spatial resolving power based on the depth at said ocean locations.

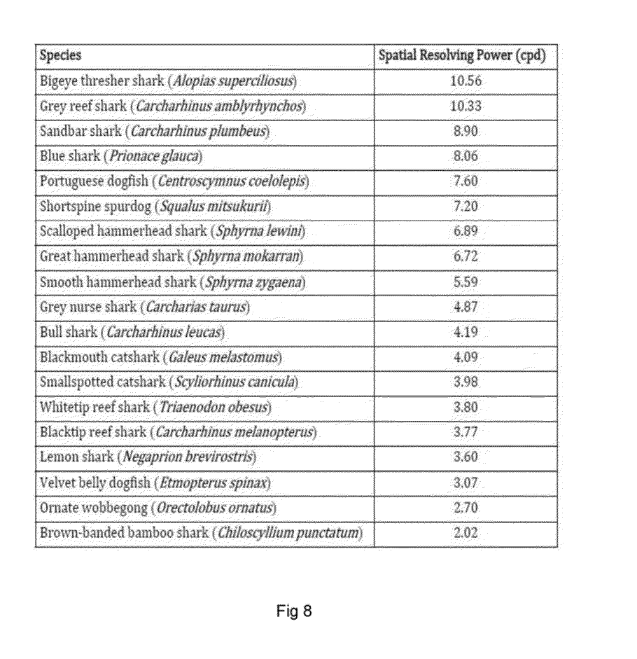

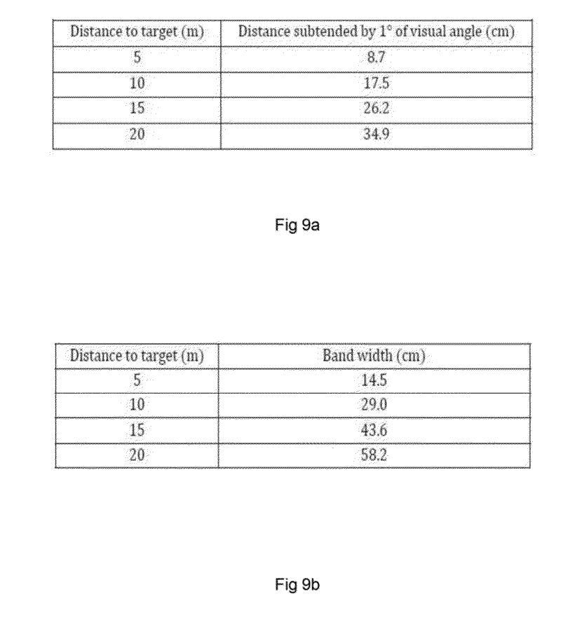

From the spatial resolving power selected, the required spacing of the banding pattern can be calculated at various distances. FIG. 8a shows tables calculating the distance subtended by one degree at various target distances. The required width of the banding can therefore be calculated at these distances as shown in FIG. 9b.

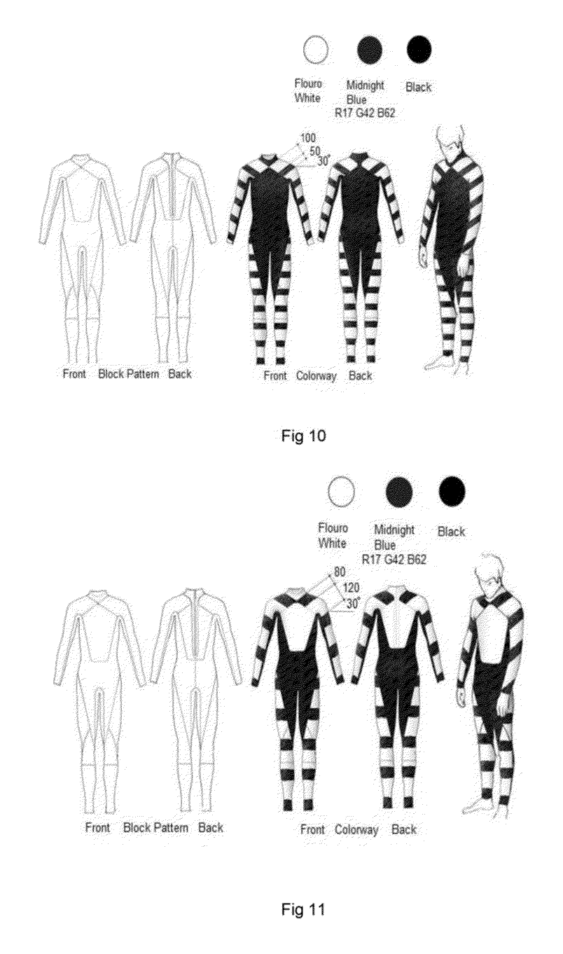

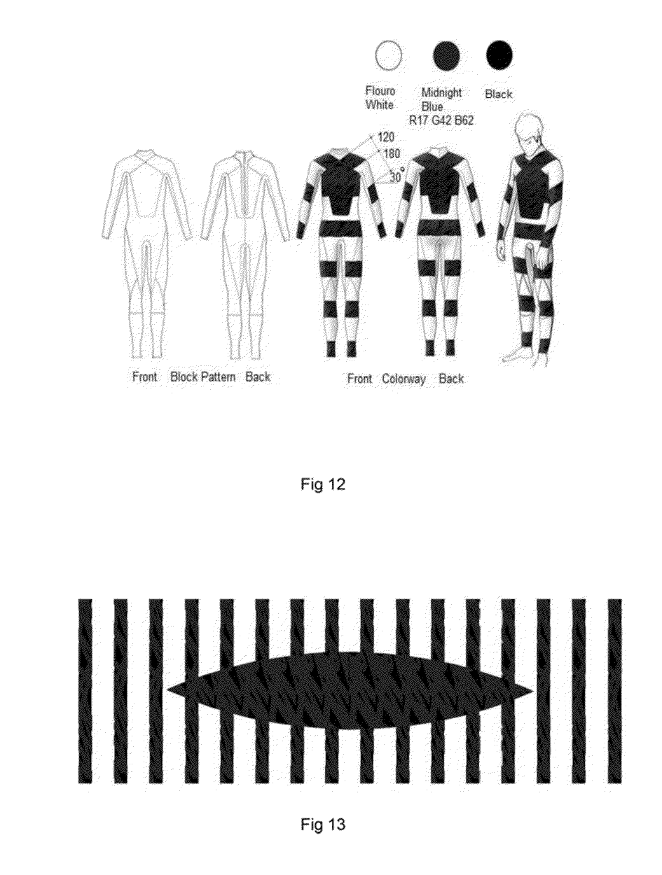

The resulting banding pattern is applied to the wetsuit material based on expected usage of the resulting wetsuit. In order to ensure discernibility of the banding pattern, band widths of varying sizes will be applied. FIG. 10 shows a first embodiment of a formed wetsuit based on a location adjacent the surface of the water (i.e. primarily for use by swimmers or surfers). FIG. 11 shows an second embodiment of a resulting wetsuit primarily for use below the surface (i.e. divers) and FIG. 12 shows a third embodiment of a resulting wetsuit primarily for use at greater depths (i.e. again for divers but where diving depth is greater). Each of the wetsuits comprise the banding pattern applied to at least the arm and leg portions in a horizontal arrangement. As can be seen, the banding width changes according to the method resulting in larger banding width at greater depths to ensure discernibility by sharks.

In the embodiment suitable for surfing, an adhesive patterned sheet may further be employed to increase the effectiveness of the banding pattern. The adhesive patterned sheet includes at least a portion thereof imprinted with a banding pattern corresponding to the banding pattern of the wetsuit. FIG. 13 shows an example of such an adhesive patterned sheet in accordance with the invention.

The adhesive patterned sheet in the embodiment shown includes a central area having a solid pattern and the banding pattern provided around the central area. The central area is provided to correspond to the area under the chest of the surfer when on the board and generally corresponds to the pattern of the wetsuit in this region. The adhesive patterned sheet is applied to the lower surface of the surfboard and the edges of the sheet are trimmed as required.

As mentioned previously, the method may include the steps of calculating or estimating reflectance spectra in various ocean locations, at various viewing angles and time values in a manner to that described previously to select an appropriate colour for the banding applied to the wetsuit.

A conspicuous target has maximal inherent contrast against its background. Reflectance cannot be less than 0 or more than 1 (equivalent to a reflection between 0 and 100%); thus, the absolute value of contrast is maximal when R(λ)=0 or R(λ)=1. From equation (4):

$$\begin{matrix}{R}_{conspicuous ( λ )} = 1 , when {R}_{cryptic ( λ )} < \frac{1}{2} , and & ( 5 ) \\ {R}_{conspicuous ( λ )} = 0 , when {R}_{cryptic ( λ )} > \frac{1}{2} & ( 6 )\end{matrix}$$

As with R_{cryptic}, R_{conspicuous} will depend on background radiance and target illumination.

From the foregoing discussions of cryptic coloration, it follows that for the upward viewing angle (where R_{cryptic(λ)}≧1) the most conspicuous colour is black. However, the distance at which a silhouette viewed from below can be detected is only marginally affected by its colour.

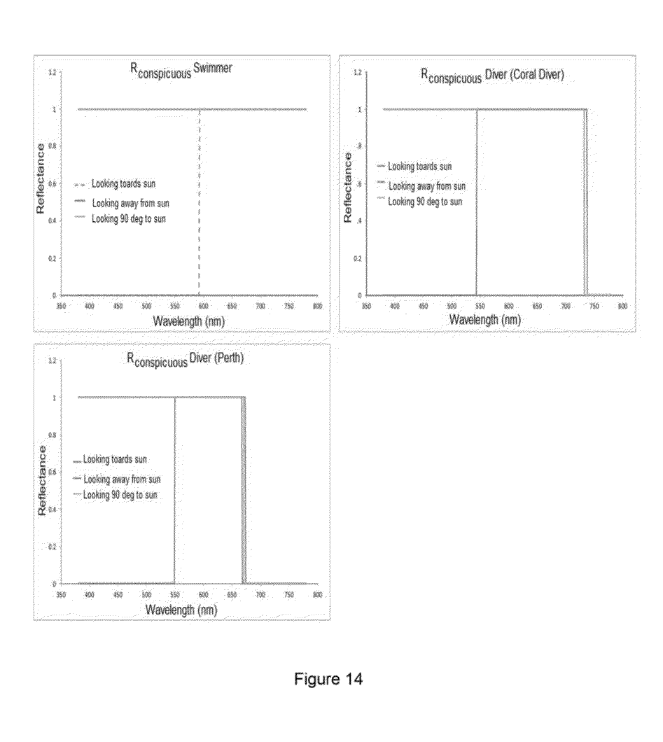

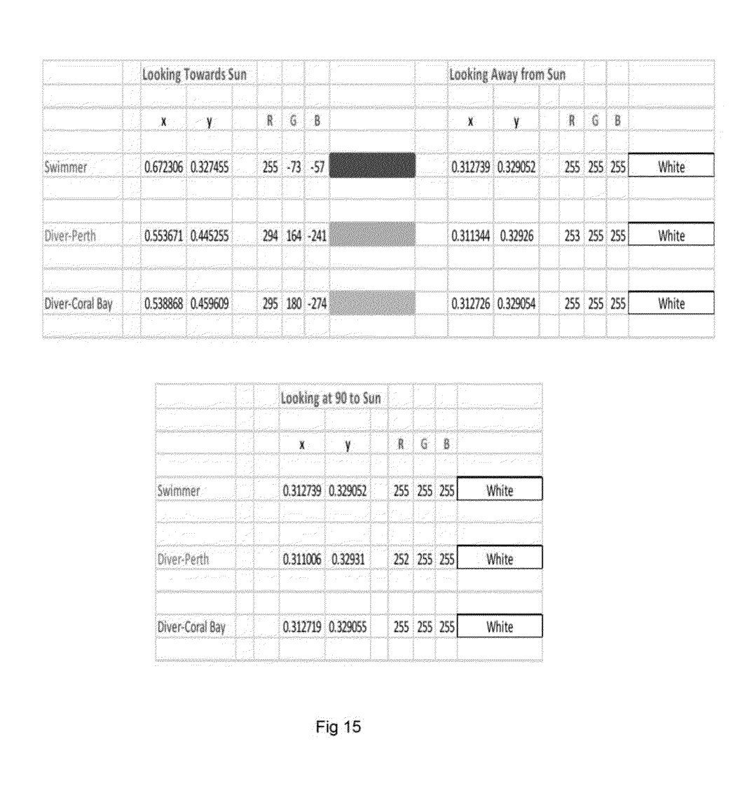

For the other viewing angles, the predicted R_{conspicuous} are summarised in the tables shown in FIG. 14. R_{conspicuous} has not been calculated for every combination of morning/noon, summer/winter, but calculated from the time and season averaged R_{cryptic} displayed in FIG. 4. Conspicuous colours for the line of sight towards the sun are shown in the CIE xy chromaticity diagram in FIG. 15. Conspicuous colours for objects viewed along the other lines of sight are essentially white (R_{conspicuous} (λ)=1) for all scenarios because R_{cryptic(λ)}<0.5 at all wavelengths shorter than approximately 650 nm. On the basis of available data, the sensitivity of the shark visual system to long wavelength light is no greater, and in general probably less than, our own visual system.

It may also be desirable to quantify the degree to which an object (‘target’) is made cryptic or conspicuous by changing its reflectance spectrum to match the background against which it is viewed. In the case of a banded, this may include assessing how well the visual system of a large shark can discriminate the target against the background. Behavioural data for visual discrimination thresholds in sharks is extremely scarce and does not exist for the three main culprits of attacks on humans: bull, tiger and white sharks. However, using established models of detection performance for vertebrate eyes and using sensible estimates of model parameters, it is possible to predict whether a target will be more or less cryptic/conspicuous to sharks under specified viewing conditions.

A number of specific parameters are required to model the visual performance (detection thresholds) of a shark. Many of these parameters are not available for species such as the white shark, due to their protected status. However, in most cases the parameters can be estimated based on existing data from other species.

The focal length (or posterior nodal distance) f of the eye and the size of the pupillary aperture together determine retinal image brightness. A larger pupil will admit more light to the eye and—for a given pupil area—an eye with a short focal length has a brighter retinal image than an eye with a long focal length. Many sharks, especially those inhabiting shallow waters, have pupils that change in size (and shape) in response to the intensity of the ambient illumination; moreover, pupil size will vary as a function of eye size (and thus body size) and between species.

Unfortunately, there are insufficient data to establish a quantitative relationship between pupil area, eye size and ambient light intensity, such that pupil area at a given depth can be specified with certainty for a given species. Moreover, focal lengths have been measured in only a few shark species and mostly in smaller specimens. Instead, several calculations and assumptions are made based on previous work to predict the likely pupil area and focal length parameters for a shark of sufficient size to fatally attack a human.

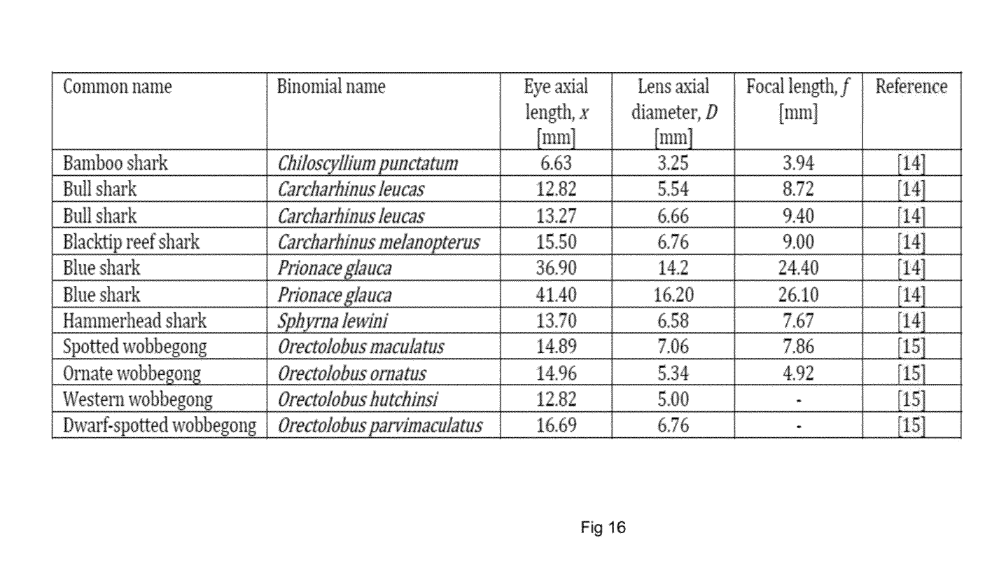

The table in FIG. 16 shoes relationships between eye axial length, lens diameter and focal length for various species of sharks. From the table we see that focal length f is related to eye axial length b x by:

f=0.6078x−1.3422 (7)

Lens diameter, D, is related to eye axial length by:

D=0.3637x+0.9778 (8)

Taking the white shark (Carcharodon carcharias) as an example, and using established length-weight relationships for this species, body mass m (g) is related to body length h (cm) by:

m=0.00766h^{3.25} (9)

Thus, a 4 m white shark has a body mass of around 1200 kg. The relationship between body mass and eye axial length for a range of elasmobranchs is:

log₁₀x=0.153 log₁₀m+1.156 (10)

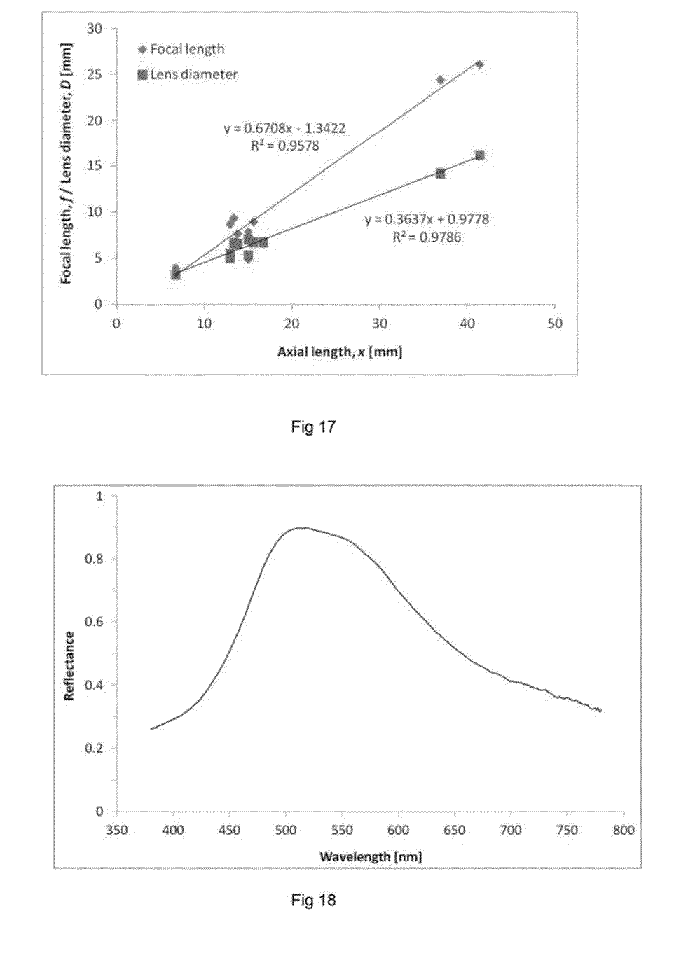

So, a 4 m white shark will have an eye axial length of 42.4 mm (eqn. 10), a lens diameter of 16.4 mm (eqn. 8) and a focal length of 27.1 mm (eqn. 7). The simplifying assumption is made that the diameter of the pupil will be no greater than the diameter of the lens (which is usually spherical or near spherical) and that the pupil is circular. This may in fact be a slight overestimate, but represents the upper limit of light entering the eye. FIG. 17 shows the relationship between the eye axial length and the focal length or lens diameter for the shark eye.

The reflective choroidal tapetum at the back of the eye covers the entire field of view in many shark species, and is generally only absent from the dorsal and ventral retinal periphery in others. Thus, the tapetum is assumed to enhance absolute sensitivity for patches of both rods and cones that are used during object detection tasks under both scotopic and photopic conditions.

The spectral reflectance of the ‘average’ shark tapetum used for the modelling (see FIG. 18) was calculated as the arithmetic mean of tapetal spectral reflectance in the blacktip shark (Carcharhinus limbatus) and the bull shark (Carcharhinus leucas), measured along the optical axis of the eye. Absolute reflectance at the wavelength of peak reflectance was set to 0.9.

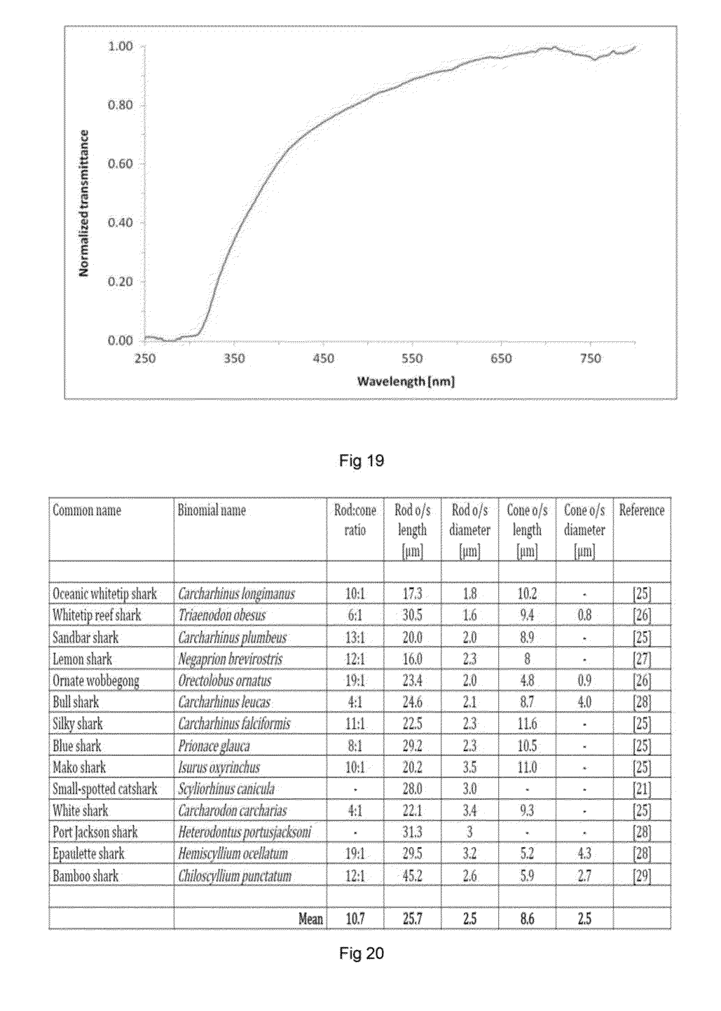

The spectral transmittance of the ocular media (cornea and lens) of a representative shark species, the black tip shark Carcharhinus limbatus, was measured using an Ocean Optics USB4000 using techniques described elsewhere. The absolute transmittances of the lens and cornea were combined and the resultant spectrum (see FIG. 19) normalized to unity at 800 nm.

Most sharks possess a duplex retina comprising both rod and cone photoreceptors. A few deepsea and exclusively nocturnal sharks are thought to have rod-only retinas with no cones. In species that possess cone photoreceptors, to date only a single type of cone visual pigment has been measured, using both spectrophotometric and molecular genetic methods.

The spectral absorption properties of rod and cone visual pigments have only been measured in a handful of shark species. There is limited variation in the wavelength of maximum absorbance (λₘₐₓ) of these pigments, with measured λₘₐₓ values ranging from 484-518 nm for rods and 532-561 nm for cones. To model the ‘average’ shark visual system, it has been chosen to use the rod λₘₐₓ value of 500 nm obtained for the tiger shark (Galeocerdo cuvier) and the cone Δₘₐₓ value of 532 nm obtained for the blacktip shark (Carcharhinus limbatus). These values are broadly representative of most bentho-pelagic or pelagic shark species studied.

The exact λₘₐₓ values of the rod and cone pigments of the white shark are not known. However, preliminary work conducted as part of this project show that the amino acid residues present in some of the key spectral tuning sites of the white shark rod pigment opsin protein are identical to those present in wobbegong sharks, which have λₘₐₓ values between 484-498 nm. It is probable therefore that the λₘₐₓ of the white shark rod pigment will sit within this range.

To date, only one type of cone pigment has been found in the retina of a shark. However, there remains a possibility that sharks may have a rudimentary form of colour vision based on the comparison of signals from rods and cones, which differ slightly in their λₘₐₓ values. In order to calculate hypothetical chromatic contrasts between rods and cones, a measure of the relative noise in each receptor channel is required, and this is given by the rod:cone ratio.

To calculate photon capture by the photoreceptors for the purposes of modelling visual contrast of an object (such as a wetsuit) against the background, the physical dimensions of the rod and cone photoreceptor outer segments are required. These are taken as the average values for rod and cone outer segment length and base diameter as measured in a variety of shark species (see Table 20).

The linear decadic absorption coefficient (‘specific absorbance’) α is a constant that characterises how easily a medium—in this case a photoreceptor outer segment containing visual pigment molecules—can be penetrated by a beam of light. The absorption coefficient is a function of wavelength and—for an infinitesimal pathlength—is related to visual pigment (decadic) absorbance A_{(λ)} by:

α_{(λ)}=αA_{(λ)} (11)

In this study, α is taken to be 0.013 μm−1 at the Aₘₐₓ of both rod and cone visual pigments.

Quantum efficiency is a measure of the probability that a photon of light absorbed by a molecule of visual pigment will initiate the phototransduction process, which generates a visual signal that can be detected by the nervous system. The quantum efficiency of both rod and cone visual pigments at all wavelengths from 380-780 nm is a well-defined parameter and is taken to be 0.67.

The simplifying assumption is made that the surface of the wetsuit (the ‘target’) approximates a flat, diffusely reflecting surface that is viewed horizontally. The spectral radiance leaving the surface of the target, L_{t(λ)}, is given by:

$${L}_{t ( λ )} = \frac{{R}_{t ( λ )} {E}_{( λ )}}{π} \qquad ( 12 )$$

R_{t(λ)} is the diffuse bihemispherical spectral reflectance of the target and E_{(λ)} is the spectral irradiance arriving at the surface of the target. The inherent (Weber) contrast C_{t(λ,0)} of the target at wavelength λ when viewed at a distance z=0 m is:

$${C}_{t ( λ , 0 )} = \frac{{L}_{t ( λ )} {L}_{b ( λ )}}{{L}_{b ( λ )}} \qquad ( 13 )$$

L_{b(λ)} is the spectral radiance of the background. As the distance from the target increases, the apparent contrast of the target against the background decreases, because light from the target is scattered out of the beam and light from the background is scattered into the beam. The spectral radiance of the target L_{t(λ,z)} at distance z from the observer is:

L_{t(λ,z)}=[L_{t(λ)}e^{-c(λ)z}]+L_{b(λ)}[1−e^{-c(λ)z}] (14)

The total spectral beam attenuation coefficient c_{(λ)} (m⁻¹) is the sum of the spectral absorption a_{(λ)} and spectral scattering b_{(λ)} coefficients for the water body in question (in this case modelled using Hydrolight v5.1). The radiance contrast C_{t(λ,z)} of the target against the water background in the horizontal line of sight at distance z becomes:

$${C}_{tz ( λ )} = \frac{{L}_{tz ( λ )} {L}_{b ( λ )}}{{L}_{b ( λ )}} \qquad ( 15 )$$

However, because the sensitivity of the visual system of an animal is species-specific and varies with wavelength, visual contrast is actually a function of photoreceptor stimulation rather than merely radiance. To determine photoreceptor stimulation, we start by calculating the optical sensitivity S_{(λ)} of a photoreceptor:

$${S}_{( λ )} = {( \frac{π}{4} )}^{2} {{D}^{2} ( \frac{d}{{f}_{( λ )}} )}^{2} {T}_{( λ )} {P}_{( λ )} \qquad ( 16 )$$

D is the diameter (m) of a circular pupil, d is the diameter (μm) of a retinal photoreceptor, f is the focal length (μm) of the eye, T_{(λ)} is the spectral transmittance (between 0 and 1) of the pre-retinal ocular media (cornea, lens, etc.). P_{(λ)} is the spectral sensitivity of the photoreceptor and is calculated as:

P=φF′_{(λ)} (17)

where φ is the quantum efficiency of the visual pigment (0.67) and F′_{(λ)} is the total fraction of incident light absorbed by the photoreceptor, given by:

F′_{(λ)}=F_{(λ)}+((1−F_{(λ)})R_{tap(λ)}F_{(λ)} (18)

R_{tap(λ)} is the spectral reflectance (between 0 and 1) of the choroidal tapetum at the back of the eye, which reflects light back along the optical axis and gives the photoreceptors a second chance to absorb photons of light that were not absorbed on the first pass. F_{(λ)} is the fraction of light absorbed by the outer segment on the first pass:

F_{(λ)}=1−10^{-αA}^{_{(λ)}}¹ (19)

where a is the decadic absorption coefficient (0.013 μm⁻¹) of the visual pigment at its Δₘₐₓ, A_{(λ)} is the spectral absorbance of the visual pigment and l is the length (μm) of the outer segment.

The physiological response Qₜᵢ (photoisomerizations s⁻¹) of a photoreceptor of type i when viewing an extend surface (i.e. not a point source) having radiance Lₜ (photons m² sr⁻¹ s⁻¹ nm⁻¹) at distance z is:

Qₜᵢ=∫_{λ}S_{t(λ)}L_{t(λ,z)})dλ (20)

Similarly, the response Q_{bi} of a photoreceptor of type i when viewing the background radiance L_{b} (photons m² sr⁻¹ s⁻¹ nm⁻¹) is:

Q_{bi}=∫_{λ}S_{i(λ)}L_{b(λ)}dλ (21)

The assumption is made that rods and cones are able to operate normally at the calculated photoreceptor photon fluxes. Elasmobranch rods appear to be able to adapt to relatively high light intensities and thus their functional range should overlap considerably with that of the cones. To account for receptor adaptation, photoreceptor responses qᵢ are normalized to the background by:

qᵢ=kᵢQᵢ (22)

The coefficients kᵢ describe the von Kries transform for chromatic adaptation and are chosen so that the response of the photoreceptor to the background (here taken as L_{b}) is unity:

$${k}_{i} = \frac{1}{{Q}_{bi}} \qquad ( 22 )$$

Fechner's law states that perceived stimulus intensity is proportional to the natural logarithm of actual stimulus intensity. Furthermore, Weber's law states that the just-noticeable difference (jnd) between two stimuli is proportional to the magnitude of the stimuli. Thus, the perceptual contrast between two visual stimuli (in this case target and background) is equal to the natural logarithm of the quotient of photoreceptor responses:

$$Δ {σ}_{i} = ln \frac{{q}_{ti}}{{q}_{bi}} \qquad ( 23 )$$

Detection performance is limited by noise in the receptor mechanism. Where specific measures of receptor signal-to-noise eᵢ are not available (as in elasmobranchs) a good approximation is:

$${e}_{i} = \frac{{ω}_{i}}{\sqrt{{n}_{i}}} \qquad ( 24 )$$

where the Weber fraction ωᵢ is the threshold increase in stimulus intensity required for detection (a value of 0.05 is typical for a wide range of vertebrate eyes and n, is the relative proportion of photoreceptors of type i). The peak rod-to-cone ratio for the white shark is 4:1 (FIG. 20); thus, e_{rod}=0.025 and e_{cone}=0.05. The achromatic contrast ΔSₐᵢ (for rod or cone systems) between target and background in perceptual space then becomes:

$$Δ {S}_{ai} = \vert \frac{Δ {σ}_{i}}{{e}_{i}} \vert \qquad ( 25 )$$

The chromatic contrast given by a theoretical dichromatic colour vision system based on opponent processing of signals from the rods and cones is:

$$Δ {S}_{c} = \sqrt{\frac{{( Δ {σ}_{rod} - Δ {σ}_{cone} )}^{2}}{{e}_{rod}^{2} + {e}_{cone}^{2}}} \qquad ( 26 )$$

The units for ΔS are jnds (just-noticeable differences), where 1 jnd represents the threshold of visual discrimination, values <1 jnd are indistinguishable and values <3 jnd are difficult to distinguish even under good viewing conditions.

Another way to interpret these calculations is to estimate the threshold detection distance of the target, i.e. the viewing distance v_{iλ}(in metres) at which the wetsuit can just be detected by the shark against the background, on the basis of brightness contrast alone:

$${v}_{i ( λ )} = \frac{ln ( \vert \frac{{c}_{ti ( λ , 0 )}}{{e}_{i}} \vert )}{{c}_{( λ )}} \qquad ( 27 )$$

where receptor type i represents a rod or a cone channel, C_{ti(λ,0)} is the achromatic visual contrast of receptor i at a distance of 0 m from the target (obtained by substituting Qₜᵢ for Lₜ and Q_{bi} for L_{b} in equation 15) and c_{(λ)} is the total spectral beam attenuation coefficient. This equation is valid for the horizontal viewing direction as the relative photoreceptor response to the background radiance does not change with viewing distance.

For all target spectra modelled, the calculated maximum viewing distance vₘₐₓ for the rod channel (which is greater than vₘₐₓ for the cones) achieved over the wavelength range 380-780 nm using equation (27) corresponded (usually within ±1 m) to the viewing distance at which rod target contrast ΔSₐ=1 jnd.

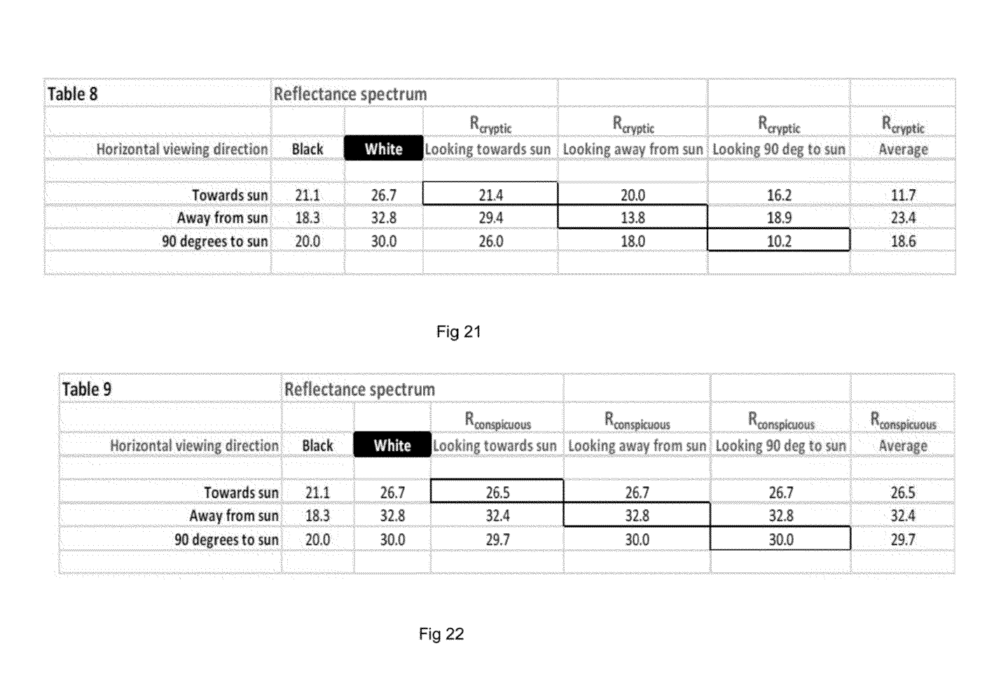

Moreover, rod ΔSₐ was always greater than both cone ΔSₐ (mostly because e_{rod}<e_{cone}) and ΔS_{c} for a hypothetical dichromatic colour channel formed by rod-cone opponency. Thus, for simplicity we present only rod vₘₐₓ for the wetsuit colours under the scenarios (depth, location, viewing angle) modelled under the project remit. In doing so, we also conclude that threshold detection of an object under the specified conditions by a shark will be made by the rods (rather than the cones) and that any chromatic processing mechanisms that exist are also of lesser importance than the rods. Typical calculations of vₘₐₓ are presented in the table of FIG. 21.

The table of FIG. 21 lists the threshold discrimination distances (m) for the three viewing-direction-specific time- and season-averaged R_{cryptics} for the ‘diver (Perth) scenario’ under light conditions occurring at 15 m depth at noon in summer. When looking towards the sun, R_{cryptic} is just as cryptic as a black surface (e.g. neoprene with R=0.1 across the spectrum), but when looking away from the sun or at 90° to the sun, the respective R_{cryptics} are significantly more cryptic than a black surface, which is theoretically detectable ˜4 m or ˜10 m further away than the relevant R_{cryptic}.

The direction-average R_{cryptic} (rightmost column in the table) is more cryptic than black when looking towards the sun, but is less cryptic than the direction-specific R_{cryptics} for their respective viewing angles. This raises two important points. The first is that, it may be better to use a traditional camouflage-type patchwork arrangement of the three different R_{cryptics} when trying to make a purely cryptic wetsuit rather than merging them into one R_{cryptic} spectrum and hoping this will work under all circumstances. The second (and related) point is that if such a strategy of disruptive camouflage is adopted, the size of the individual patches must be big enough so that they do not fall below the resolving power of the observer, which would effectively result in the merging of the different colour patches towards the direction-averaged R_{cryptic}.

The table of FIG. 22 lists the threshold discrimination distances (m) for the three viewing-direction-specific time- and season-averaged R_{conspicuous}, for the ‘diver (Perth) scenario’ under light conditions occurring at 15 m depth at noon in summer. It is evident that none of the direction-specific R_{conspicuous} or the direction-averaged R_{conspicuous} is more conspicuous than a white surface under these conditions, which may be detected ˜6-14 m further away than a black surface.

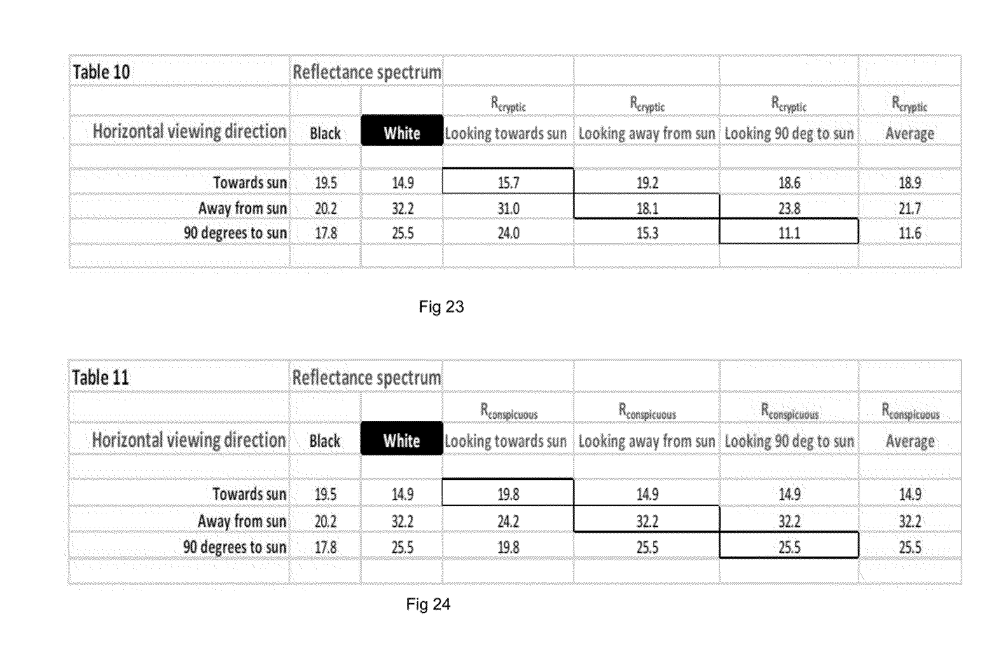

A different scenario is summarised in the table of FIG. 23, which lists the threshold discrimination distances (m) for the three viewing-direction-specific time- and season-averaged R_{cryptic} for the ‘swimmer scenario’ under light conditions occurring on the surface of water 10 m deep in the morning in summer. Once again, the threshold detection distance is shortest (i.e. the target is more cryptic) for the direction-specific R_{cryptic} along that specific line of sight, when compared to a black surface.

The table of FIG. 24 lists the threshold discrimination distances (m) for the three viewing-direction-specific time- and season-averaged R_{conspicuous} for the ‘swimmer scenario’ under light conditions occurring on the surface of water 10 m deep in the morning in summer. When looking towards the sun, R_{conspicuous} is not significantly more conspicuous than black. For the other viewing angles, R_{conspicuous} provides an equal contrast to a white surface.

Taken together, these results (and others not shown) suggest that R_{cryptic} are less easily detectable by a hypothetical shark when viewed along the specific line of sight for which they were predicted than a surface that approximates a black neoprene wetsuit. The degree to which R_{cryptic} renders a surface less cryptic is variable and depends on viewing angle, time, season and depth.

It will be readily apparent to persons skilled in the relevant arts that various modifications and improvements may be made to the foregoing embodiments, in addition to those already described, without departing from the basic inventive concepts of the present invention.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. A method of designing a material comprising the steps of:
defining one or more ocean locations;
measuring or calculating reflectance spectra at said locations along one or more predefined viewing angles;
selecting from each reflectance spectra a wavelength range located in or around a maximum region of said reflectance spectra; and
creating the material by applying colours from each of the wavelength ranges to portions of the material surface.

19. A method in accordance with claim 18, wherein each of the ocean locations comprises a depth and/or a geographic location.

20. A method in accordance with claim 19, including the step of defining a plurality of time values associated with each ocean location, each of the time values corresponding to a particular time of day and/or year, wherein the reflectance spectra are measured or calculated at each ocean location at each time value.

21. A method in accordance with claim 20, wherein the reflectance spectra measured or calculated at each ocean location are averaged over the time values to define the reflectance spectra at each viewing angle.

22. A method in accordance with claim 21, wherein the viewing angles include towards the sun, away from the sun, and 90 degrees to the sun.

23. A method in accordance with claim 22, wherein the colours selected are applied to the material in a camouflage patchwork pattern.

24. A method in accordance with claim 23, including the step of calculating the visual discrimination characteristics including the spatial resolving power of at least one species of shark and applying patches of the patchwork pattern to the material such that the size of the patches do not fall below the spatial resolving power.

25. A method in accordance with claim 24, wherein the material comprises portions of a first colour, a second colour and a third colour, wherein the first colour is defined by RGB values in the ranges 90 to 100/180 to 195/210 to 220, the second colour is defined by RGB values in the ranges −20 to −10/75 to 85/105 to 115 and the third colour is defined by RGB values in the ranges 5 to 15/110 to 120/140 to 150.

26. A method in accordance with claim 25, wherein the first, second and third colours are defined by the RGB values, 99/188/216, −14/81/108 and 10/115/145.

27. A method of designing a material comprising the steps of:
defining one or more sets of ocean locations;
calculating the visual discrimination characteristics of at least one species of shark at said ocean locations; and
creating the material by applying a pattern to portions of the material surface based on said visual discrimination characteristics.

28. A method in accordance with claim 27, including the steps of measuring or calculating reflectance spectra at said locations along one or more predefined viewing angles and selecting said colours based on maximizing contrast with the background at said locations.

29. A method in accordance with claim 28, including the steps of calculating or estimating the spatial resolving power of each species of shark.

30. A method in accordance with claim 29, wherein the spatial resolving power as represented in cycles per degree for each species of shark is calculated or estimated and the pattern applied to the material comprises a series of bands where the band spacing is determined based on the cycles per degree for the shark to ensure the bands are discernible by the shark at a set of predefined distances.

31. A method in accordance with claim 30, wherein the spatial resolving power is adjusted for expected ambient lighting conditions at said ocean locations at selected time values.

32. A method in accordance with claim 31, including the further step of calculating or estimating the variance of said band spacing based on depth at said ocean locations.

33. A material produced in accordance with a method as defined in claim 18.

34. An item of underwater apparel formed from a material as defined in claim 33.

35. A material produced in accordance with a method as defined in claim 27.

36. An item of underwater apparel formed from a material as defined in claim 35.

37. A method in accordance with claim 18, wherein the material comprises portions of a first colour, a second colour and a third colour, wherein the first colour is defined by RGB values in the ranges 90 to 100/180 to 195/210 to 220, the second colour is defined by RGB values in the ranges −20 to −10/75 to 85/105 to 115 and the third colour is defined by RGB values in the ranges 5 to 15/110 to 120/140 to 150.
